(19) United States
(12) Patent Application Publication
(10) Pub. No.: US 2026/0142564 A1
(43) Pub. Date: May 21, 2026

(54) PFC Power Supply and Control Method Thereof

(71) Applicant: Leadtrend Technology Corporation, Zhubei City (TW)

(72) Inventors: Yao-Tsung CHEN, Zhubei City (TW); Ming-Chan TSOU, Zhubei City (TW); Kuan-Hsien CHOU, Zhubei City (TW)

(21) Appl. No.: 19/374,033

(22) Filed: Oct. 30, 2025

(30) Foreign Application Priority Data
Nov. 19, 2024 (TW) 113144513

(51) Int. Cl. H02M 1/42; H02M 1/00; H02M 1/32

(52) U.S. Cl. CPC H02M 1/4208; H02M 1/0009; H02M 1/0012; H02M 1/0025; H02M 1/32

(57) ABSTRACT

A PFC power supply includes a PFC circuit converting an AC power source into an intermediate power source and a PWM circuit converting the intermediate power source into an output power source. A power controller controls the PWM circuit and includes an AC voltage detector and a protection circuit. The AC voltage detector detects the AC power source to provide a power-good signal. The protection circuit provides an input-power protection for the PWM circuit when the power-good signal indicates normality of the AC power source. When the power-good signal indicates abnormality of the AC power source, the input-power protection is disabled or eased, so that the PWM circuit continues converting the intermediate power source to support the output power source.

### CROSS-REFERENCE TO RELATED APPLICATION

This application claims priority to and the benefit of Taiwan Application Series Number 113144513 filed on Nov. 19, 2024, which is incorporated by reference in its entirety.

### BACKGROUND

The present disclosure relates generally to a power factor correction (PFC) power supply, and more particularly to a PFC power supply capable of sustaining an output power source when an AC power source disappears.

Power supplies with PFC are often used in lighting or high-power electrical applications. On one hand, such power supplies aim to achieve a power factor as close to the ideal value of 1 as possible, so that from the perspective of the AC mains power source, the power supply behaves essentially like a resistive load. On the other hand, the output power delivered by the PFC-enabled power supply must meet the required voltage and current specifications at the output terminal.

FIG. 1 illustrates an example of power supply 100 with power factor correction. Power supply 100 includes power factor correction circuit 102 and pulse width modulation (PWM) circuit 104. PFC circuit 102 is responsible for correcting the power factor of power supply 100, drawing energy from AC power source V_{AC} to generate intermediate power source V_{INV}. PWM circuit 104 uses intermediate power source V_{INV} as its input power to generate output power source V_{O}, which supplies power to load 106. In simple terms, PFC circuit 102 converts AC power V_{AC} into intermediate power source V_{INV}, while PWM circuit 104 converts intermediate power V_{INV} into output power source V_{O}.

In some applications, load 106 might require that output voltage source V_{O} be maintained for a minimum hold-up time (T_{HOLD-UP}) after AC power source V_{AC} disappears or is disconnected. FIG. 1 also shows that power supply 100 provides AC detection signal ACD to inform load 106 of the status of AC power source V_{AC}. FIG. 2 illustrates example waveforms or logic states for some of the signals shown in FIG. 1. AC power source V_{AC} begins to disappear at moment t_{AC-OFF}, which may result from the power plug being pulled from the socket for example. At power-loss notification moment tS, power supply 100 informs load 106 of the abnormal AC power status via AC detection signal ACD. Since AC power source V_{AC} is no longer supplying energy, at output-drop moment tD after moment t_{AC-OFF}, output power source V_{O} starts to drop abruptly and can no longer be maintained. Output voltage hold-up time T_{HOLD-UP} is defined as the duration between power-loss notification moment tS and output-drop moment tD. The longer hold-up time T_{HOLD-UP}, the better, as it provides load 106 with more time to prepare for the power outage.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates a PFC power supply in the art;

FIG. 2 illustrates example waveforms or logic states for some of the signals shown in FIG. 1;

FIG. 3 illustrates a PFC power supply according to embodiments of the present invention;

FIG. 4 illustrates a PWM circuit and a power controller;

FIG. 5 illustrates signal waveforms and logic states based on FIGS. 3 and 4; and

FIG. 6 provides a magnified view of high-voltage signal V_{HV} and power-good signal PG near power-loss notification moment tS shown in FIG. 5.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

According to an embodiment of the present invention, a PFC power supply converts an AC power source into an intermediate power source, which is then converted by a PWM circuit into an output power source. The PFC power supply detects the AC power source to generate a power-good signal, which can be translated into an AC detection signal sent to a load. In one embodiment, a hold-up time is defined as the duration from a power-loss notification moment (when the load is informed of an abnormal AC power status via the AC detection signal) to an output-drop moment (when the voltage of the output power source can no longer be maintained above a preset voltage level and drops off).

An embodiment according to the invention extends the hold-up time using two approaches: one is to advance the power-loss notification moment as early as possible to promptly inform the load of the AC power issue; the other is to fully utilize the intermediate power source to sustain the output power source, thereby delaying the output-drop moment.

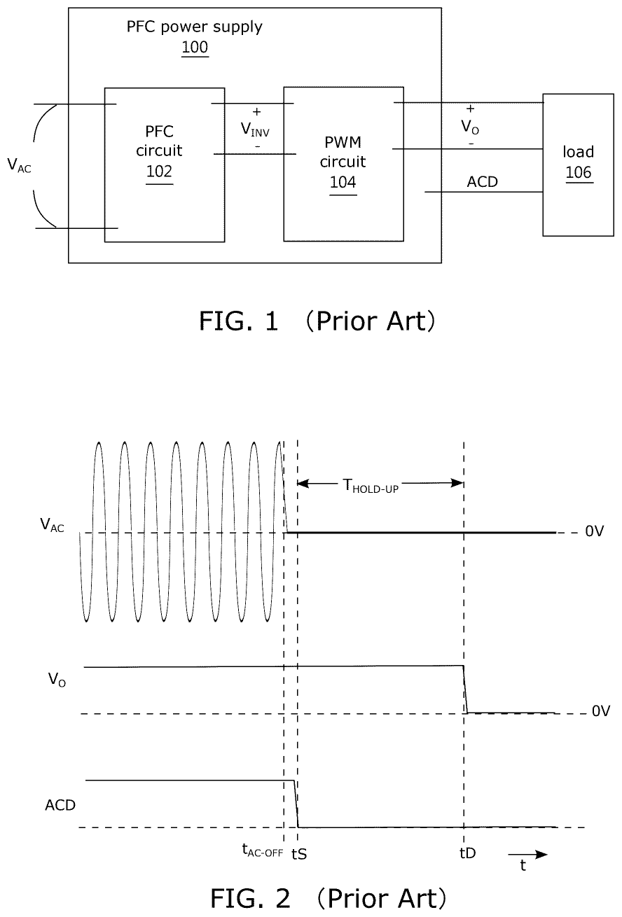

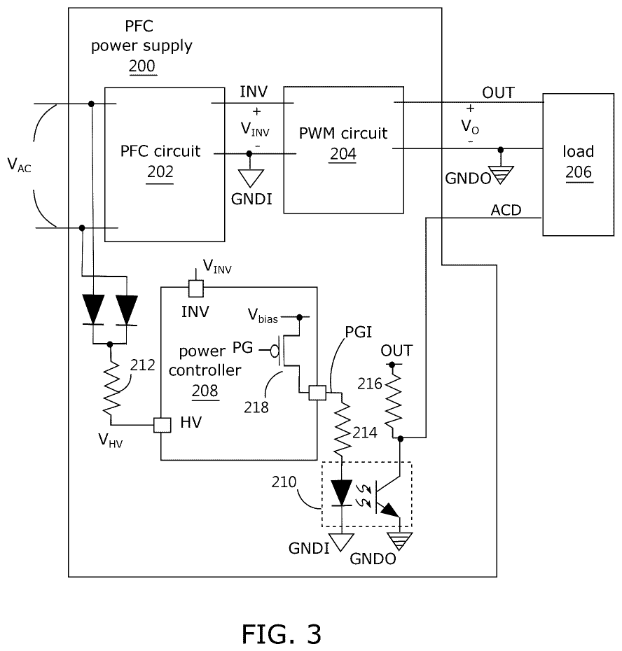

FIG. 3 illustrates PFC power supply 200 according to embodiments of the present invention, which includes PFC circuit 202 and PWM circuit 204. Features in FIG. 3 that are the same or similar to those in FIG. 1 can be referenced from the earlier explanation and might not be repeated here. In FIG. 3, AC power source V_{AC} and intermediate power source V_{INV} are located on the primary side, while the output power source V_{O} is on the secondary side. PWM circuit provides galvanic isolation to isolate the primary side from the secondary side. The 0V reference on the primary side is defined by input ground line GNDI, while the 0V reference on the secondary side is defined by output ground line GNDO. Intermediate power source V_{INV} is generally located on intermediate power rail INV, and output power source V_{O} is on output power rail OUT.

On the primary side, two diodes and resistor 212 rectify the voltage of AC power source V_{AC}, generating high-voltage signal V_{HV} at high-voltage node HV. Based on high-voltage signal V_{HV}, power controller 208 detects the presence of the AC power source V_{AC} and generates power-good signal PG. Power-good signal PG controls PMOS transistor 218 to generate inverted power-good signal PGI. Through PMOS transistor 218, resistors 214 and 216, and photocoupler 210, power-good signal PG from the primary side is translated into AC detection signal ACD on the secondary side and delivered to load 206.

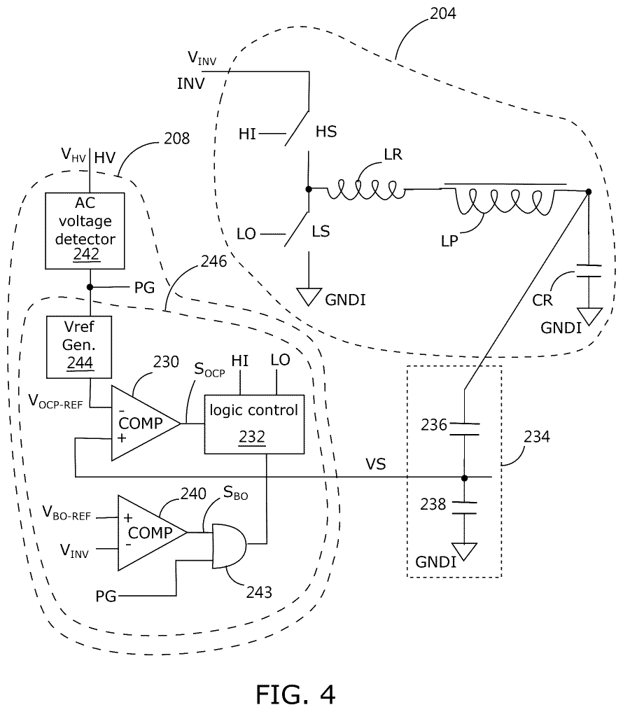

FIG. 4 illustrates PWM circuit 204 and power controller 208. Power controller 208 outputs signals HI and LO to control PWM circuit 204.

PWM circuit 204 is essentially an LLC power converter, including power switches HS and LS forming a half-bridge, a resonant circuit composed of inductor LR, primary winding LP (in a transformer), and resonant capacitor CR, and voltage divider 234 formed by capacitors 236 and 238, with interconnections shown in FIG. 4. Voltage divider 234 provides current-sense signal VS, which roughly represents an input current PWM circuit 204 drains from intermediate power source V_{INV}.

Power controller 208 includes AC voltage detector 242 and protection circuit 246. AC voltage detector 242 uses high-voltage signal V_{HV} to detect the status of AC power source V_{AC} and generate power-good signal PG. In one embodiment, a logic “1” for power-good signal PG indicates normality of AC power source V_{AC}, while a logic “0 ” indicates abnormality or a power outage.

Protection circuit 246 provides two types of input power protections: INV overcurrent protection and INV undervoltage protection. INV overcurrent protection limits the current PWM circuit 204 drains from intermediate power source V_{INV}. INV undervoltage protection (also known as brownout protection) ensures that PWM circuit 204 only operates when intermediate power source V_{INV} has a sufficient voltage level. These two protections are input-power protections for PWM circuit 204.

Comparator 230 in FIG. 4 compares overcurrent reference signal V_{OCP-REF} with current-sense signal VS to limit the current PWM circuit 204 drains from intermediate power source V_{INV}, thereby providing INV overcurrent protection. In one embodiment, when current-sense signal VS exceeds overcurrent reference signal V_{OCP-REF}, overcurrent signal S_{OCP} triggers the INV overcurrent protection, and logic control 232 turns OFF power switch HS immediately, allowing the PWM circuit 204 to enter the next switching cycle. For example, after turning OFF power switch HS, power switch LS is turned ON.

Comparator 240 compares intermediate power source V_{INV} with undervoltage reference voltage V_{BO-REF} to determine whether the voltage of intermediate power source V_{INV} is too low, providing INV undervoltage protection. When AC power source V_{AC} is normal, power-good signal PG is logic “1”, enabling AND gate 243 to pass undervoltage signal S_{BO} output from comparator 240 to logic control 232. Once intermediate power source V_{INV} drops below undervoltage reference voltage V_{BO-REF}, logic control 232, in response to undervoltage signal S_{BO}, keeps power switches HS and LS turned OFF, halting the power conversion of PWM circuit 204 until intermediate power source V_{INV} recovers to a sufficient voltage level.

According to an embodiment of the present invention, when AC power source V_{AC} becomes abnormal, or high-voltage signal V_{HV} is constantly below 65V for example, power-good signal PG switches to logic “0”, which accordingly eases the INV overcurrent protection and disables the INV undervoltage protection provided by protection circuit 246. In other words, when AC power source V_{AC} turns abnormal, PWM circuit 204 continues converting intermediate power source V_{INV} into output power source V_{O}, the voltage of intermediate power source V_{INV} is allowed to drop more, and the current PWM circuit 204 drains from intermediate power source V_{INV} can be higher. This means that, compared to normal AC power conditions, PWM circuit 204 is permitted to draw more energy from intermediate power source V_{INV} when AC power source V_{AC} is lost, in order to sustain output power source V_{O} longer, thereby extending the output voltage hold-up time.

Reference voltage generator 244 provides overcurrent reference signal V_{OCP-REF} based on power-good signal PG. In one embodiment, the value of overcurrent reference signal V_{OCP-REF} when power-good signal PG is logic “1” is smaller than it is when power-good signal PG is logic “0.” In other words, when AC power source V_{AC} is abnormal, reference voltage generator 244 increases overcurrent reference signal V_{OCP-REF}, thereby increasing the maximum current allowed to be drained by PWM circuit 204 and easing the INV overcurrent protection. For instance, the value of overcurrent reference signal V_{OCP-REF} when power-good signal PG is logic “0 ” is approximately 1.3 times the value when power-good signal PG is logic “1.”

Furthermore, when power-good signal PG is logic “0 ,” AND gate 243 accordingly blocks undervoltage signal S_{BO} output from comparator 240 from reaching logic control 232, effectively disabling the INV undervoltage protection. In this scenario, PWM circuit 204 keeps on converting power even if intermediate power source V_{INV} drops below undervoltage reference voltage V_{BO-REF}.

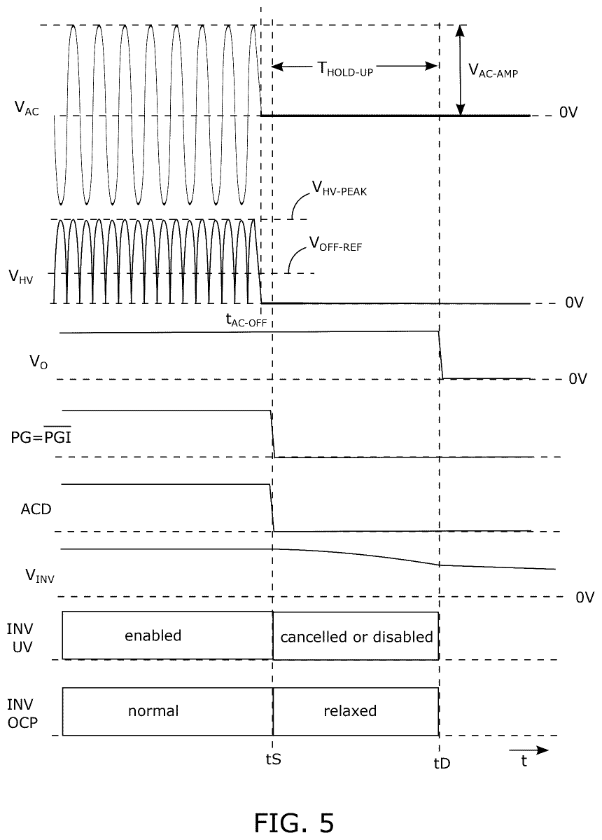

FIG. 5 illustrates signal waveforms and logic states based on FIGS. 3 and 4 to describe operating behaviors of PFC power supply 200.

As shown in FIG. 5, AC power source V_{AC} starts to disappear at moment t_{AC-OFF}. Before moment T_{AC-OFF} when AC power source V_{AC} is normal, high-voltage signal V_{HV} at high-voltage node HV exhibits an M-shaped waveform with peak value V_{HV-PEAK} approximately equal to amplitude V_{AC-AMP} of AC power source V_{AC}. AC voltage detector 242 compares high-voltage signal V_{HV} with power-loss reference voltage V_{OFF-REF}. At power-loss notification moment tS when high-voltage signal V_{HV} has remained below power-loss reference voltage V_{OFF-REF} for a sustained duration, AC voltage detector 242 sets power-good signal PG to “0” and inverted signal PGI to “1”. Therefore, at around power-loss notification moment tS, load 206 on the secondary side is notified of the abnormality in the AC power source V_{AC} via AC detection signal ACD.

As shown in FIG. 5, output voltage hold-up time T_{HOLD-UP} begins at power-loss notification moment tS and ends at output-drop moment tD, the moment when output power V_{O} can no longer be maintained.

FIG. 5 also shows that when AC power source V_{AC} is normal (i.e., before power-loss notification moment tS), power controller 208 provides both INV undervoltage protection (brownout protection) and INV overcurrent protection through comparators 230 and 240. After AC power source VAC is confirmed to be abnormal (i.e., after power-loss notification moment tS), the INV undervoltage protection is disabled, and the INV overcurrent protection is eased, as a result of the actions of AND gate 243 and reference voltage generator 244 shown in FIG. 4. Accordingly, after AC power source VAC is abnormal, PWM circuit 204 continues converting intermediate power source V_{INV} to support output power source V_{O}. Disabling the INV undervoltage protection and easing the INV overcurrent protection delays the appearance of the output-drop moment tD, thereby extending the output voltage hold-up time T_{HOLD-UP}.

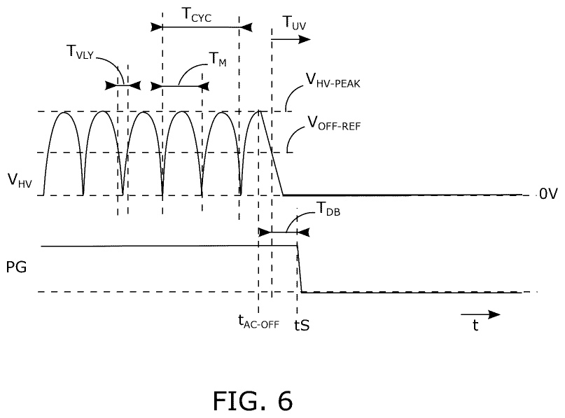

FIG. 6 provides a magnified view of high-voltage signal V_{HV} and power-good signal PG near power-loss notification moment tS shown in FIG. 5. When AC power source V_{AC} is normal, it has cycle time T_{CYC} that is approximately twice cycle time T_{M} of high-voltage signal V_{HV}. In the following example, when AC power source V_{AC} is normal, cycle time T_{CYC} is 20 ms, cycle time TM is 10 ms, both AC voltage amplitude V_{AC-AMP} and peak value V_{HV-PEAK} are 127V (=90V×1.414), and power-loss reference voltage V_{OFF-REF} is 63.5V (equal to ½ of V_{AC-AMP}). These values are merely examples and do not intend to limit the invention. In FIG. 6, valley duration T_{VLY} refers to the time period when high-voltage signal V_{HV} remains below power-loss reference voltage V_{OFF-REF} while AC power source V_{AC} is normal. In one embodiment, power-loss reference voltage V_{OFF-REF} is set to ½ of AC voltage amplitude V_{AC-AMP}, and valley duration T_{VLY} is 3.33 ms (⅓ of cycle time T_{M}). In another embodiment, power-loss reference voltage V_{OFF-REF} is less than ½ of AC voltage amplitude V_{AC-AMP}.

AC voltage detector 242 in FIG. 4 compares high-voltage signal V_{HV} with power-loss reference voltage V_{OFF-REF} to generate power-good signal PG. In FIG. 6, when high-voltage signal V_{HV} falls below power-loss reference voltage V_{OFF-REF}, AC voltage detector 242 begins counting undervoltage duration T_{UV}. When high-voltage signal V_{HV} rises back above power-loss reference voltage V_{OFF-REF}, undervoltage duration T_{UV} is reset to 0. If undervoltage duration T_{UV} exceeds preset delay time T_{DB}, AC voltage detector 242 changes the logic value of power-good signal PG from “1” to “0”, to indicate that AC power source V_{AC} becomes abnormal, as shown in FIG. 6. Under normal conditions, undervoltage duration T_{UV} should be approximately equal to valley duration T_{VLY}. When undervoltage duration T_{UV} exceeds valley duration T_{VLY}, it likely indicates that AC power source V_{AC} has disappeared, and thus AC power source V_{AC} can be considered abnormal. To prevent false triggering, preset delay time T_{DB} is preferably longer than valley duration T_{VLY}—preferably, twice as long. In one embodiment, delay time T_{DB} is at least ⅓ of cycle time T_{M} but no more than one full period T_{M}. In other words, delay time T_{DB} could be a predetermined value roughly between ⅙ and ½ of cycle time T_{CYC}. In one embodiment of the invention, delay time T_{DB} is predetermined to be between 3.3 ms and 10 ms.

In an embodiment, power-loss reference voltage V_{OFF-REF} is preferably less than or equal to half AC voltage amplitude V_{AC-AMP}. As seen in FIG. 6, when AC power source V_{AC} is normal, a smaller power-loss reference voltage V_{OFF-REF} results in a shorter valley duration T_{VLY}, allowing AC voltage detector 242 to detect the abnormalities of AC power source V_{AC} earlier and generate an earlier power-loss notification moment tS. An earlier power-loss notification moment tS leads to a longer output voltage hold-up time T_{HOLD-UP}.

In a conventional power factor correction (PFC) power supply, an output voltage hold-up time T_{HOLD-UP} is around 30 ms in simulation. By adopting the improvements described in the embodiments of the invention, the output voltage hold-up time T_{HOLD-UP} can be significantly extended—up to 64 ms.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method in use of a PFC power supply, wherein the PFC power supply converts an AC power source into an intermediate power source, which is converted into an output power source by a PWM circuit, the control method comprising;
detecting the AC power source to generate a power-good signal;
providing an input-power protection for the PWM circuit when the power-good signal indicates normality of the AC power source;
easing or disabling the input-power protection when the power-good signal turns to indicate abnormality of the AC power source, so that the PWM circuit continues converting the intermediate power source to support the output power source.

2. The control method of claim 1, wherein the input-power protection is a brownout protection comprising:
comparing the intermediate power source with an undervoltage reference voltage; and
stopping the PWM circuit from converting the intermediate power source into the output power source if the intermediate power source is below the undervoltage reference voltage; and
the control method disables the brownout protection when the power-good signal turns to indicate the abnormality.

3. The control method of claim 2, comprising:
comparing the intermediate power source with an undervoltage reference voltage to generate an undervoltage signal;
providing a logic control to control the PWM circuit; and
blocking the output undervoltage signal from reaching the logic control when power-good signal indicates the abnormality.

4. The control method of claim 1, wherein the input-power protection is an overcurrent protection comprising:
providing a current-sense signal to represent an input current the intermediate power source provides to the PWM circuit;
comparing the current-sense signal with an overcurrent reference signal; and
turning OFF a power switch in the PWM circuit when the current-sense signal exceeds the overcurrent reference signal; and
the control method increases the overcurrent reference signal when the power-good signal turns to indicate the abnormality, thereby easing the overcurrent protection.

5. The control method of claim 1, wherein the PFC power supply comprises a PFC circuit for correcting a power factor of the PFC power supply and providing the intermediate power source.

6. The control method of claim 1, comprising:
rectifying the AC power source to generate a high-voltage signal;
comparing the high-voltage signal with a power-loss reference voltage to count an undervoltage duration; and
determining the power-good signal in response to the undervoltage duration.

7. The control method of claim 6, wherein the AC power source has an AC voltage amplitude when the power-good signal indicates the normality of the AC power source, and the power-loss reference voltage is less than ½ of the AC voltage amplitude.

8. The control method of claim 1, comprising:
turning the power-good signal to indicate the abnormality if the undervoltage duration is longer than a preset delay time.

9. The control method of claim 7, wherein the AC power source has a cycle time when the power-good signal indicates the normality, and the preset delay time is between ⅙ and ½ of the cycle time.

10. A PFC power supply, providing an output power source, comprising:
a PFC circuit converting an AC power source into an intermediate power source;
a PWM circuit converting the intermediate power source into the output power source; and
a power controller for controlling the PWM circuit, comprising:
an AC voltage detector for detecting the AC power source to provide a power-good signal; and
a protection circuit providing at least one input-power protection for the PWM circuit when the power-good signal indicates normality of the AC power source;
wherein when the power-good signal indicates abnormality of the AC power source the protection circuit disables or eases the input-power protection, so that the PWM circuit continues converting the intermediate power source to support the output power source.

11. The PFC power supply of claim 10, comprising:
a rectifier rectifying the AC power source to provide a high-voltage signal;
wherein the AC voltage detector compares the high-voltage signal with a power-off reference voltage to provide the power-good signal.

12. The PFC power supply of claim 11, wherein the AC power source has an AC voltage amplitude when the power-good signal indicates the normality of the AC power source, and the power-loss reference voltage is less than ½ of the AC voltage amplitude.

13. The PFC power supply of claim 11, wherein the AC voltage detector starts counting an undervoltage duration when the high-voltage signal is less than the power-loss reference voltage, and determines the power-good signal in response to the undervoltage duration.

14. The PFC power supply of claim 13, wherein the AC voltage detector turns the power-good signal to indicate the abnormality if the undervoltage duration is longer than a preset delay time.

15. The PFC power supply of claim 14, the AC power source has a cycle time when the power-good signal indicates the normality, and the preset delay time is between ⅙ and ½ of the cycle time.

16. The PFC power supply of claim 10, wherein the protection circuit comprises:
a reference voltage generator providing an overcurrent reference signal when the power-good signal indicates the normality; and
a comparator comparing the overcurrent reference signal with a current-sense signal, wherein the current-sense signal represents an input current that the PWM circuit drains from intermediate power source;
when the power-good signal indicates the abnormality the reference voltage generator increases the overcurrent reference signal, thereby easing the input-power protection.

17. The PFC power supply of claim 10, the protection circuit comprises:
a comparator comparing the intermediate power source with an undervoltage reference voltage; and
a logic circuit receiving an output from the comparator, to stop the PWM circuit from converting the intermediate power source when the intermediate power source is less than the undervoltage reference voltage; and
the output is blocked from being received by the logic circuit when the power-good signal indicates the abnormality, thereby disabling the input-power protection.
